(19) United States
(12) Patent Application Publication
(10) Pub. No.: US 2015/0120487 A1
(43) Pub. Date: Apr. 30, 2015

(54) METHODS AND APPARATUS FOR FACILITATING DELIVERY OF A SERVICE ASSOCIATED WITH A PRODUCT

(71) Applicant: Andrew Arthurs, Chicago, IL (US)

(72) Inventor: Andrew Arthurs, Chicago, IL (US)

(21) Appl. No.: 14/247,881

(22) Filed: Apr. 8, 2014

Related U.S. Application Data
(60) Provisional application No. 61/896,426, filed on Oct. 28, 2013.

(51) Int. Cl. G06Q 30/06

(52) U.S. Cl. CPC G06Q 30/0611
USPC 705/26.4

(57) ABSTRACT

Methods and apparatus for facilitating delivery of a service associated with a product are disclosed. In general, in an embodiment, a retail website receives a product selection and jobsite information indicative of an intended end-use location of the product where the associated service is needed. The website then solicits bids for the service and allows the user to select a winning bid. If the user selects a bid, the website facilitates delivering the service associated with the selected product.

### CROSS-REFERENCE TO RELATED APPLICATIONS

This application claims the benefit of U.S. Provisional Patent Application Ser. No. 61/896,426, filed Oct. 28, 2013, which is incorporated herein by reference in its entirety.

### FIELD OF INVENTION

The present disclosure relates in general to retail websites, and, in particular, to methods and apparatus for facilitating delivery of a service associated with a product.

### BACKGROUND

People often purchase products on the Internet that require installation, assembly, arrangement, setup, hookup, configuration, and/or other services. For example, people frequently purchase major appliances, such as refrigerators, ovens, washers, dryers, furnaces, air conditioners etc. via a retail website. Some purchasers perform these services for the products they purchase by themselves. Other purchasers make arrangements with a third party service provider (e.g., to install the product). On those occasions, the purchaser may contact the service provider via another website. What is needed is one integrated product purchase and service provider decision experience.

### BRIEF DESCRIPTION OF THE DRAWINGS

FIG. 1 is a block diagram of an example network communication system.

FIG. 2 is a block diagram of an example computing device.

FIG. 3 is a flowchart of an example process for facilitating servicing of a product.

FIG. 4 is a flowchart of another example process for facilitating servicing of a product.

FIG. 5 is a flowchart of another example process for facilitating servicing of a product.

FIG. 6 is a flowchart of another example process for facilitating servicing of a product.

FIG. 7 is an example overview screenshot.

FIG. 8 is an example service selection screenshot.

FIG. 9 is an example contractor bid creation screenshot.

FIGS. 10-11 are an example quote selection screenshot.

FIGS. 12-13 are an example contractor/customer interaction screenshot.

### DETAILED DESCRIPTION OF THE PREFERRED EMBODIMENTS

Briefly, methods and apparatus for facilitating delivery of a service associated with a product are disclosed. In general, a retail website receives a product selection and jobsite information indicative of the intended end-use location for the product where the service is needed. The website then solicits bids for the service and allows the user to select a winning bid. If the user selects a bid, the website facilitates delivery of the service associated with the selected product. Among other features, systems employing the disclosed system are able to offer a potential customer one integrated product purchase and service provider decision experience.

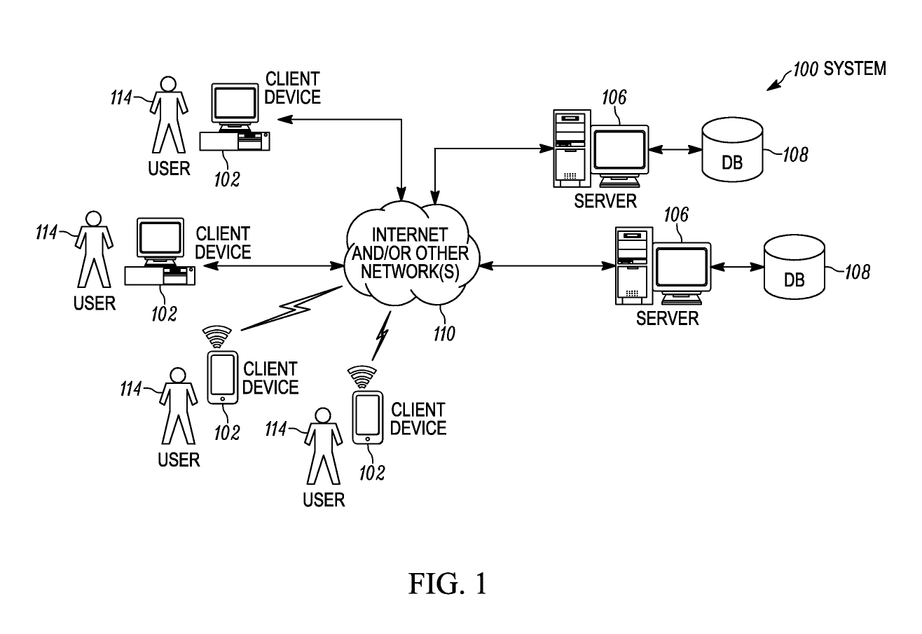

Turning now to the figures, the present system is most readily realized in a network communication system 100. A block diagram of certain elements of an example network communication system 100 is illustrated in FIG. 1. The illustrated system 100 includes one or more client devices 102 (e.g., computer, television, camera, phone), one or more web servers 106, and one or more databases 108. Each of these devices may communicate with each other via a connection to one or more communications channels 110 such as the Internet or some other wired and/or wireless data network, including, but not limited to, any suitable wide area network or local area network. It will be appreciated that any of the devices described herein may be directly connected to each other instead of over a network. In addition, for ease in explanation, this description may refer to a client device 102 and a server 106 communicating (e.g., an interactive website). It will be appreciated that any number of client devices 102 and servers 106 may be used in the same manner as the simplified one-to-one examples used herein.

The web server 106 stores a plurality of files, programs, and/or web pages in one or more databases 108 for use by the client devices 102 as described in detail below. The database 108 may be connected directly to the web server 106 and/or via one or more network connections. The database 108 stores data as described in detail below.

One web server 106 may interact with a large number of client devices 102. Accordingly, each server 106 is typically a high end computer with a large storage capacity, one or more fast microprocessors, and one or more high speed network connections. Conversely, relative to a typical server 106, each client device 102 typically includes less storage capacity, a single microprocessor, and a single network connection.

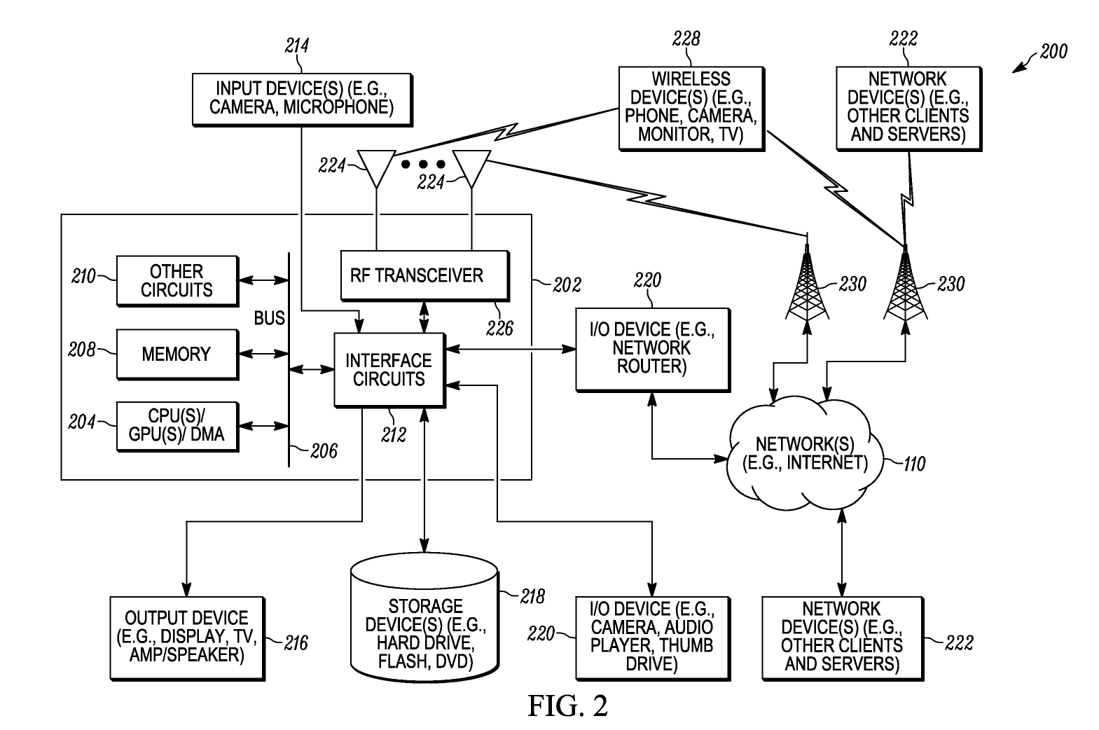

Each of the devices illustrated in FIG. 1 (e.g., client 102 and/or server 106) may include certain common aspects of many computing devices such as microprocessors, memories, direct memory access units, peripherals, etc. FIG. 2 is a block diagram of an example computing device.

The example computing device 200 includes a main unit 202 which may include, if desired, one or more processing units 204 electrically coupled by an address/data bus 206 to one or more memories 208, other computer circuitry 210, and one or more interface circuits 212. The processing unit 204 may include any suitable processor or plurality of processors. In addition, the processing unit 204 may include other components that support the one or more processors. For example, the processing unit 204 may include a central processing unit (CPU), a graphics processing unit (GPU), and/or a direct memory access (DMA) unit.

The memory 208 may include various types of non-transitory memory including volatile memory and/or non-volatile memory such as, but not limited to, distributed memory, read-only memory (ROM), random access memory (RAM) etc. The memory 208 typically stores a software program that interacts with the other devices in the system as described herein. This program may be executed by the processing unit 204 in any suitable manner. The memory 208 may also store digital data indicative of documents, files, programs, web pages, etc. retrieved from a server and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, isopoint, camera, voice recognition system, accelerometer, global positioning system (GPS), and/or any other suitable input device.

One or more displays, printers, speakers, monitors, televisions, high definition televisions, and/or other suitable output devices 216 may also be connected to the main unit 202 via the interface circuit 212. For example, a display for displaying video data may be a cathode ray tube (CRTs), liquid crystal displays (LCDs), electronic ink (e-ink), and/or any other suitable type of display.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the device 200.

The computing device 200 may also exchange data with one or more input/output (I/O) devices 220. For example, I/O devices 220 may include network routers, cameras, audio players, thumb drives etc.

The computing device 200 may also exchange data with other network devices 222 via a connection to a network 110. The network connection may be any type of network connection, such as an Ethernet connection, digital subscriber line (DSL), telephone line, coaxial cable, wireless base station 230, etc. Users 114 (e.g., customers and contractors) of the system 100 may be required to register with a server 106. In such an instance, each user 114 may choose a user identifier (e.g., e-mail address) and a password which may be required for the activation of services. The user identifier and password may be passed across the network 110 using encryption built into the user's browser. Alternatively, the user identifier and/or password may be assigned by the server 106.

In some embodiments, the computing device 200 may be a wireless device 200. In such an instance, the device 200 may include one or more antennas 224 connected to one or more radio frequency (RF) transceivers 226. The transceiver 226 may include one or more receivers and one or more transmitters operating on the same and/or different frequencies. For example, the device 200 may include a Bluetooth transceiver, a Wi-Fi transceiver, and/or diversity cellular transceivers. The transceiver(s) 226 allow the device 200 to exchange signals, such as voice, video and any other suitable data, with other wireless devices 228, such as a phone, camera, monitor, television, and/or high definition television. For example, the device 200 may send and receive wireless telephone signals, text messages, audio signals and/or video signals directly and/or via a base station 230.

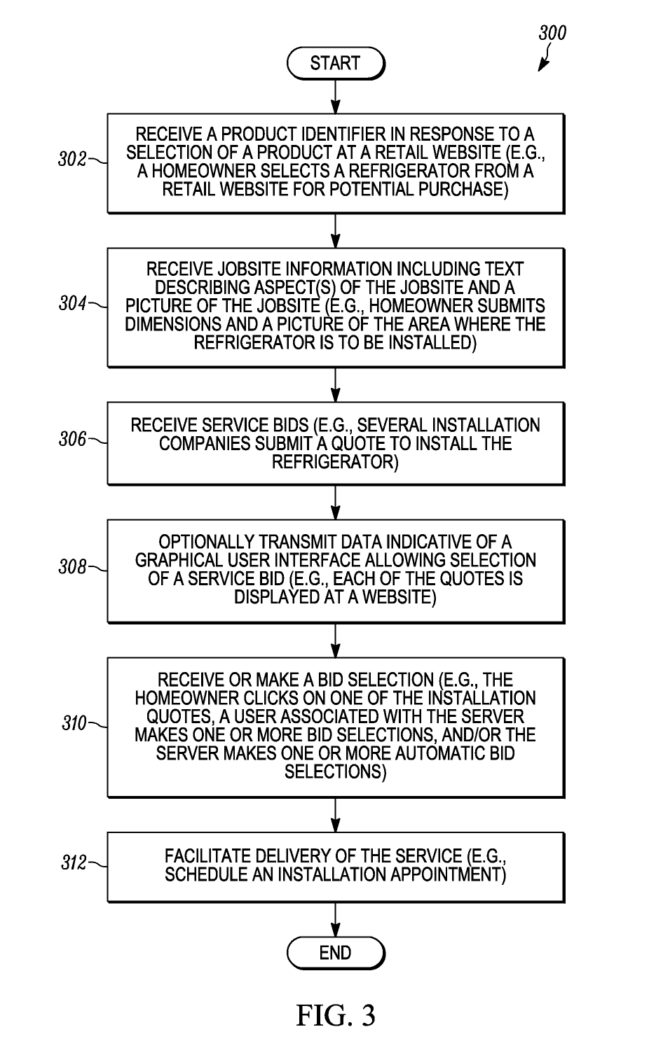

A flowchart of an example process 300 for facilitating servicing of a product is illustrated in FIG. 3. The process 300 may be carried out by one or more suitably programmed processors, such as a CPU executing software (e.g., block 204 of FIG. 2). The process 300 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 300 is described with reference to the flowchart illustrated in FIG. 3, it will be appreciated that many other methods of performing the acts associated with process 300 may be used. For example, the order of many of the operations may be changed, and some of the operations described may be optional.

In general, a retail website receives a product selection and jobsite information indicative of a location a product is to be serviced. The website then solicits bids for the service and allows the user to select a winning bid. If the user selects a bid, the website facilitates delivery of the service associated with the selected product.

More specifically, in this example, the process 300 begins when a retail website server 106 receives a product identifier in response to a selection of a product (block 302). For example, a user 114, such as a homeowner, may select a refrigerator from a retail website for potential purchase. In addition, the user 114 may upload jobsite information to the server 106 (block 304). The jobsite information preferably includes text describing one or more aspect(s) of the jobsite and one or more pictures of the jobsite. For example, the user 114 may be prompted for the physical dimensions of the area where the refrigerator is to be installed as well as a picture of the area. The jobsite information may also include any other suitable information, such as a video of the jobsite, text entered by the user 114, predetermined text selectable by the user 114, etc.

In response to sending the product identifier and the jobsite information to one or more service providers, the server 106 receives one or more service bids (block 306). For example, several installation companies may submit a quote to install the refrigerator. The server 106 may then transmit data indicative of a graphical user interface to the user's client device 102, thereby allowing the user 114 to select one of the service bids (block 308). Each service bid preferably includes a price quote and one or more time periods when the service may be performed. For example, each of the service bids may be displayed by a website where the user 114 may select one of the service bids by selecting one of the time periods.

The server 106 then receives or makes one or more bid selections (block 310). For example, the user 114 may click on one of the service bids displayed by the website. Alternatively, or in addition, a different user associated with the server 106 may make one or more bid selections. For example, a customer service agent may reduce the number of service bids that are forwarded to the end user 114. Similarly, the server 106 may make one or more bid selections automatically. For example, the server 106 may reduce the number of service bids that are forwarded to the end user 114 automatically based on price, provider, etc. If the number of service bids is reduced, but more than one service bid remains, the end user 114 preferably makes the final service bid selection (e.g., buy clicking on one of the service bids displayed by the website). In some cases, only one service bid is sent to the end user 144 (e.g., only one service bid was received from the service providers or the number of service bids was reduced to one). In such an instance, the end user 114 either approves or disapproves the service bid. The server 106 then facilitates delivery of the service associated with the product (block 312). For example, the server 106 may schedule an installation appointment, generate an installation agreement, and/or send out a bill once the installation is completed.

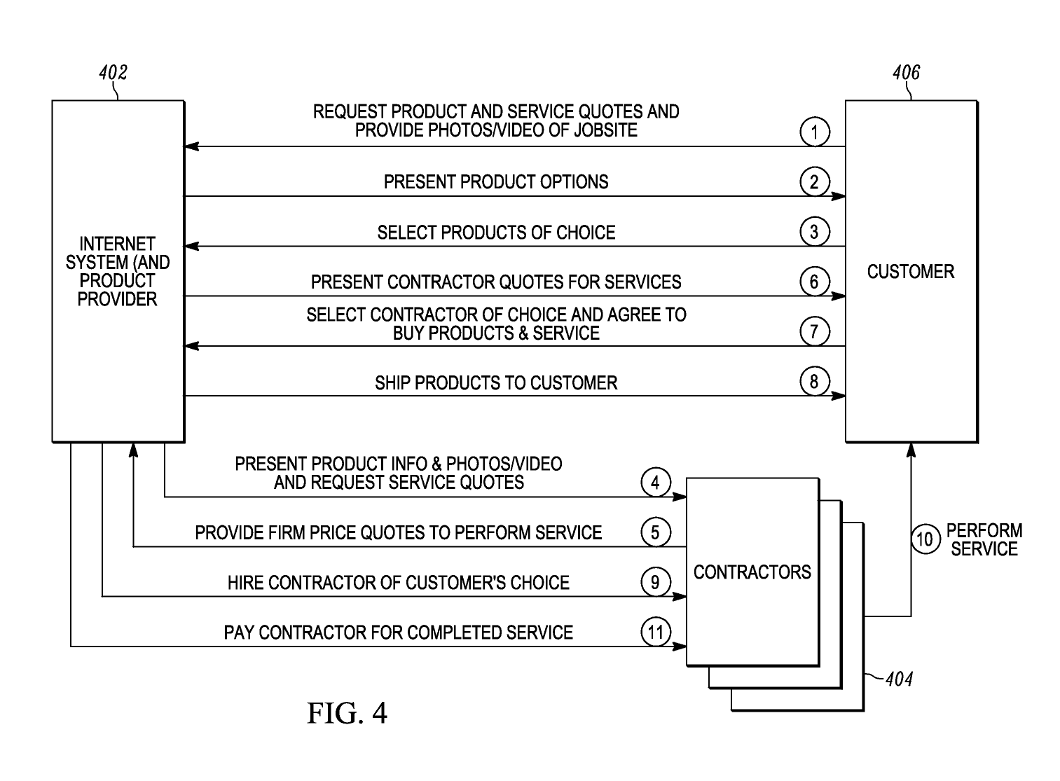

A flowchart of another example process 400 for facilitating servicing of a product is illustrated in FIG. 4. The process 400 may be carried out by one or more suitably programmed processors, such as a CPU executing software (e.g., block 204 of FIG. 2). The process 400 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 400 is described with reference to the flowchart illustrated in FIG. 4, it will be appreciated that many other methods of performing the acts associated with process 400 may be used. For example, the order of many of the operations may be changed, and some of the operations described may be optional.

As in the example illustrated in FIG. 3, in this example, the operator of the server 106 (e.g., e-commerce store) sells the product to the user 114, and the user 114 supplies the jobsite information (e.g., descriptions, photos, videos). The communications system 100 interconnects goods suppliers 402, service providers 404, and end users 114. When a user 114 wishes to acquire a product, such as a lavatory faucet, the user 114 selects the desired product for sale by an e-commerce retailer 402. The consumer additionally provides jobsite information, such as location, description of work to be performed, and preferably one or more photographs of the job site.

The retailer 402 then transmits job information, including the product details and job site details to one or more service providers 404 capable of performing the required work. The service providers 404 review the product information and job site information and submit bids over the Internet (or another network) for performing the work to the retailer 402. The retailer 402 presents the received bids to the end user 114, who selects a winning bid for performing the work. The contracting and payment process may be carried out through the retailer 402, as shown in this example. In alternate embodiments, the contracting and payment process for the work to be performed may be carried out external to the retailer 402, such as directly between the service provider 404 and the end user 114.

More specifically, the customer 406 requests a product and/or service quotes and provides photos and/or videos of the job site to the Internet system (and product provider) 402 (block 1). In response, the Internet system 402 presents options to the customer 406 (block 2). The customer 406 then selects one or more of the products and sends the selection to the Internet system 402 (block 3). The Internet system 402 presents the product information and photos/videos to the contractors 404 and requests service quotes (block 4). In response, the contractors 404 provide firm price quotes to perform the service to the Internet system 402 (block 5). The Internet system 402 presents these contractor quotes to the customer 406 (block 6). The customer 406 then selects one of the contractors and agrees to buy the products and services (block 7). The Internet system 402 then ships the products to the customer 406 (block 8). In addition, the Internet system 402 sends a message to the selected contractor 404 indicating the contractor has been hired for the job (block 9). The selected contractor 404 than performs the service for the customer 406 (block 10). When the job is completed, the Internet system 402 pays the contractor 404 for the service (block 11).

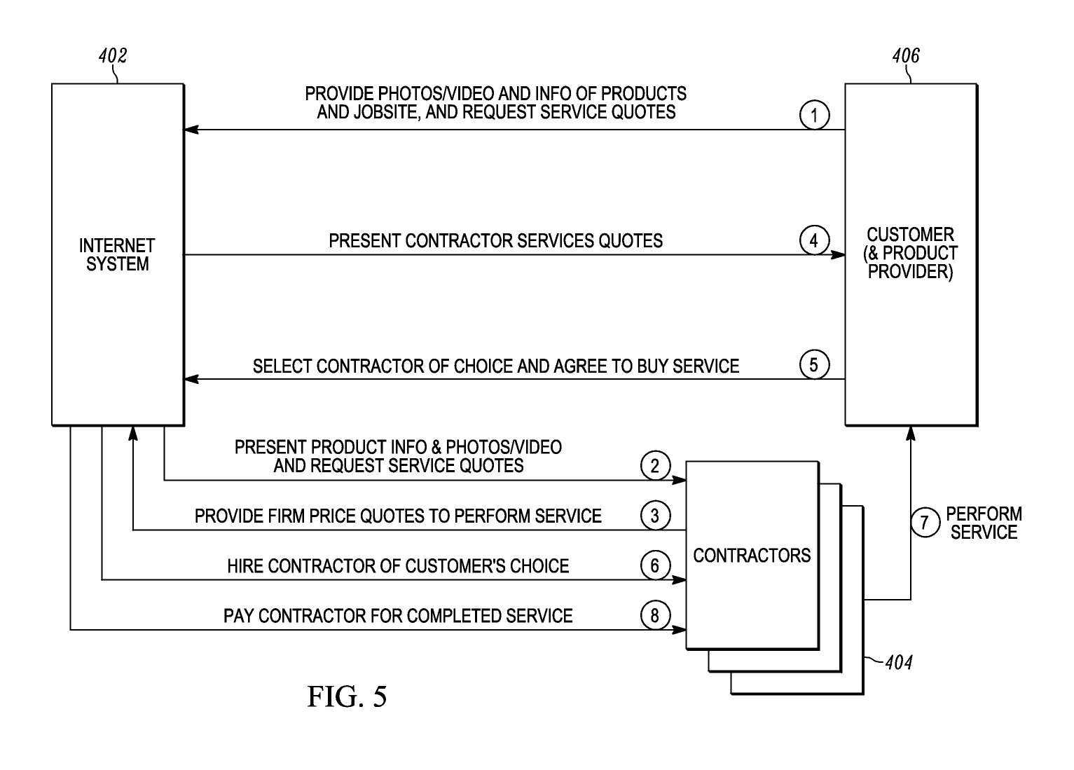

A flowchart of another example process 500 for facilitating servicing of a product is illustrated in FIG. 5. The process 500 may be carried out by one or more suitably programmed processors, such as a CPU executing software (e.g., block 204 of FIG. 2). The process 500 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 500 is described with reference to the flowchart illustrated in FIG. 5, it will be appreciated that many other methods of performing the acts associated with process 500 may be used. For example, the order of many of the operations may be changed, and some of the operations described may be optional.

In this example, the user 114 supplies the product and the jobsite information. For example, the user 114 may already have purchased (or otherwise acquired) the product, and may only require a service provider 404 to install, assemble, arrange, set up, hook up, configure, and/or perform some other service associated with the acquired product (e.g., an install and set up a wireless Internet router). In this case, the user 114 provides product details in addition to any job site information that is necessary for the service provider 404 to provide a bid for performing the work.

More specifically, the customer 406 requests a service quote and provides photos and/or videos of the job site, photos and/or videos of the products, and/or product information to the Internet system 402 (block 1). The Internet system 402 then presents the product information and/or photos/videos to the contractors 404 and requests service quotes (block 2). In response, the contractors 404 provide firm price quotes to perform the service to the Internet system 402 (block 3). The Internet system 402 presents these contractor quotes to the customer 406 (block 4). The customer 406 then selects one of the contractors and agrees to buy the products and services (block 5). The Internet system 402 sends a message to the selected contractor 404 indicating the contractor has been hired for the job (block 6). The selected contractor 404 than performs the service for the customer 406 using the customer supplied products (block 7). When the job is completed, the Internet system 402 pays the contractor 404 for the service (block 8).

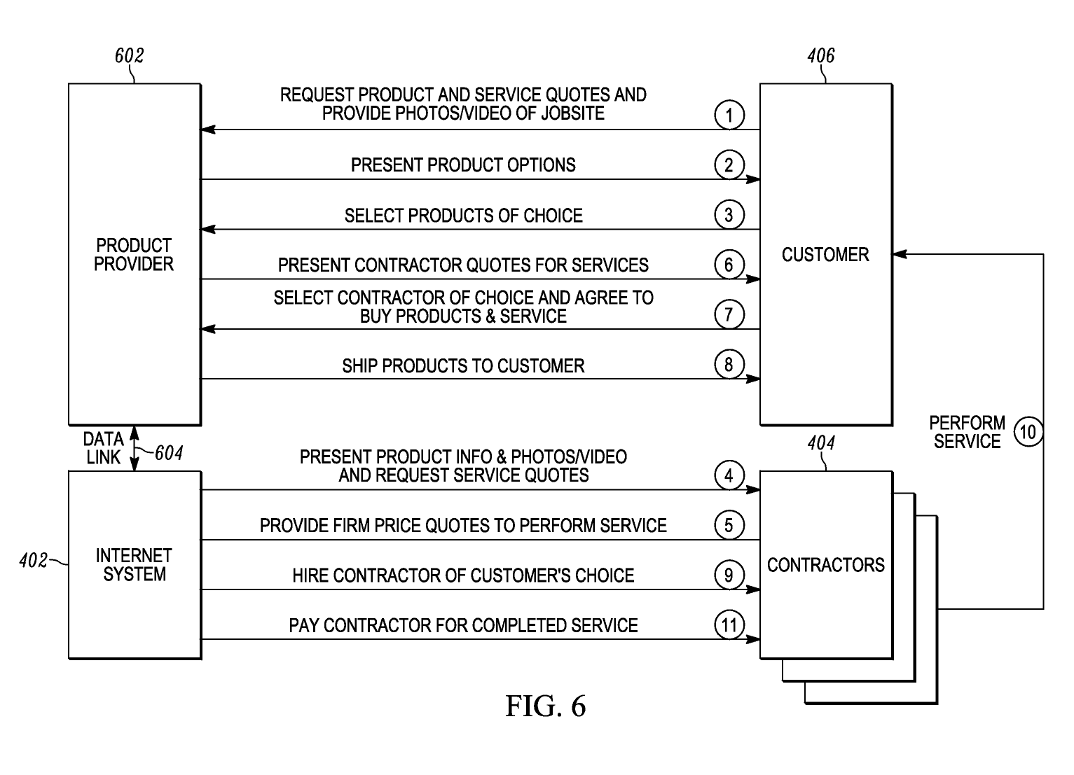

A flowchart of another example process 600 for facilitating servicing of a product is illustrated in FIG. 6. The process 600 may be carried out by one or more suitably programmed processors, such as a CPU executing software (e.g., block 204 of FIG. 2). The process 600 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 600 is described with reference to the flowchart illustrated in FIG. 6, it will be appreciated that many other methods of performing the acts associated with process 600 may be used. For example, the order of many of the operations may be changed, and some of the operations described may be optional.

In this example, a third-party e-commerce merchant 602 supplies the product with an associated data link 604. Product photos, product descriptions, and similar information are transmitted between the product provider 602 and the server 106 via an application programming interface (API) over the network 110. The server 106 may be part of a separate and distinct entity from the product provider 602. In this case, the product provider 602 may still be an Internet retailer, but the server 106 is part of an independent third party. However, the product provider 602 is in communication with the server 106, and provides the product information to the product provider 602.

More specifically, the customer 406 requests a product and/or service quotes and provides photos and/or videos of the job site to a product provider 602 (block 1). In response, the product provider 602 presents options to the customer 406 (block 2). The customer 406 then selects one or more of the products and sends the selection to the product provider 602 (block 3). After communicating from the product provider 602 to the Internet system 402 via a data link 604, the Internet system 402 presents the product information and photos/videos to the contractors 404 and requests service quotes (block 4). In response, the contractors 404 provide firm price quotes to perform the service to the Internet system 402 (block 5). After communicating from the Internet system 402 to the product provider 602 via the data link 604, the product provider 602 presents these contractor quotes to the customer 406 (block 6). The customer 406 then selects one of the contractors and agrees to buy the products and services (block 7). The product provider 602 then ships the products to the customer 406 (block 8). After communicating from the product provider 602 to the Internet system 402 via the data link 604, the Internet system 402 sends a message to the selected contractor 404 indicating the contractor has been hired for the job (block 9). The selected contractor 404 than performs the service for the customer 406 (block 10). When the job is completed, the Internet system 402 pays the contractor 404 for the service (block 11).

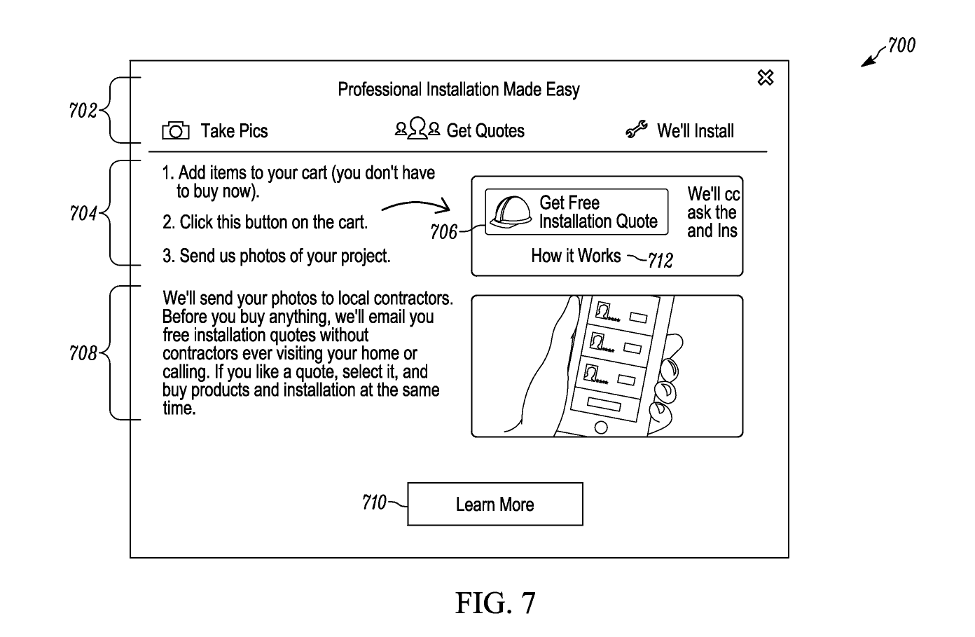

An example overview screenshot 700 is illustrated in FIG. 7. In this example, a brief overview 702 is displayed informing a user 114 that the professional installation service is as easy as taking pictures, getting quotes, and receiving the installation service. The example overview screenshot 700 also displays a sequence of steps 704 including a first step instructing the user 114 to add items to a virtual shopping cart. The example sequence of steps 704 also includes a second step instructing the user 114 to click a “Get Free Installation Quotes” button 706 in order to receive free installation quotes. The example sequence of steps 704 also includes a third step instructing the user 114 to send photos of the user's project.

The example overview screenshot 700 also includes a detailed overview 708 informing the user 114 that the photos will be sent to local contractors 404 and that prior to purchasing the product, the free installation quotes will be emailed to the user 114 without the need for the contractors 404 visiting the user's home or calling the user 114. The detailed overview 708 then informs the user 114 that the user 114 may optionally select one of the quotes and buy the product and associated installation at the same time. The example overview screenshot 700 also includes a “Learn More” button 710 and a “How it Works” hyperlink 712 that the user 114 may select to receive even more details about the process.

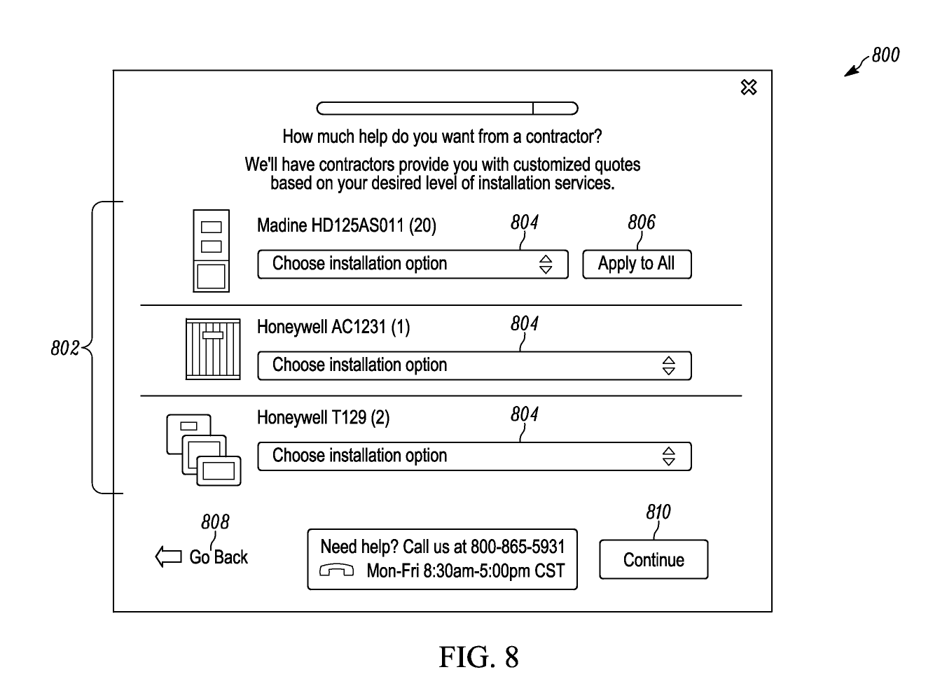

An example service selection screenshot 800 is illustrated in FIG. 8. In this example, the user 114 has already selected three products 802 in a conventional manner. Each product 802 is associated with a service selection menu 804. Using each service selection menu 804, the user 114 may optionally select a desired type of service for each product 802. For example, the user 114 may select to have a product installed, assembled, arranged, set up, hooked up, configured, and/or have some other service associated with a product performed. In this example, the user 114 may also press an “Apply to All” button 806 to automatically duplicate the user's choice from the first service selection menu 804 to each of the remaining service selection menus 804. The user 114 may also go back to a previous screen (e.g., a product selection screen) using a “Go Back” hyperlink 808 or continue to a next screen (e.g., an order summary screen) using a “Continue” button 810.

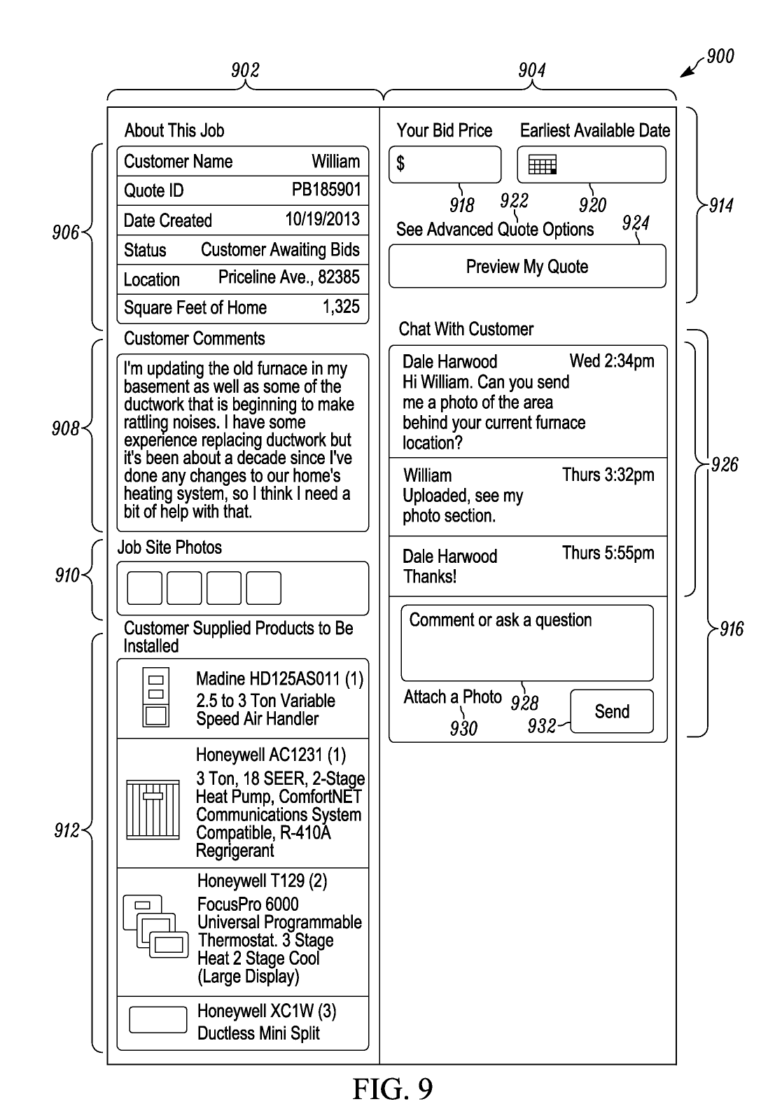

An example contractor bid creation screenshot 900 is illustrated in FIG. 9. In this example, a job information section 902 includes information about the job, and a communication section 904 allows a contractor 404 to interact with the customer 406 and quote the job. In this example, the job information section 902 includes an “About This Job” section 906, a “Customer Comments” section 908, a “Job Site Photos” section 910, and a “Customer Supplied Products to Be Installed” section 912.

The example “About This Job” section 906 includes the customer's name, a unique quote identifier, the date the quote request was created, the current status of the quote request, the location of the job, and the square feet of the home. The “About This Job” section 906 may also include any other suitable information about the job such as spatial measurements, construction materials, available building mechanicals, water/sewer/fuel supply, voltages, geographic characteristics, available human resources, colors, sounds, etc.]. The example “Customer Comments” section 908 includes any text entered by the customer 406. For example, the customer 406 may give the dimensions of the jobsite. The example “Job Site Photos” section 910 includes photos uploaded by the customer 406 of the job site. For example, the customer 406 may upload photos of an existing wall oven. The “Customer Supplied Products to Be Installed” section 912 includes information about the products selected by the customer 406, such as pictures, names, descriptions, diagrams, technical details, required tools, required parts, and/or any other information facilitating the installation, assembly, arrangement, setup, hookup, configuration, and/or other servicing of the products selected by the customer 406.

The example communication section 904 includes a quote submission section 914 and a “Chat With Customer” section 916. The example quote submission section 914 incudes a “Your Bid Price” input box 918, an “Earliest Available Date” input box 920, a “See Advanced Quote Options” hyperlink 922, and a “Preview My Quote” button 924. The contractor 404 may enter a dollar (or other suitable currency) amount in the “Your Bid Price” input box 918 and date in the “Earliest Available Date” input box 920. The contractor 404 may see additional quoting options by clicking the “See Advanced Quote Options” hyperlink 922. For example, a quoting form may allow the contractor 404 to enter more than one quote with different options associated with each quote (e.g., one quote to install a refrigerator and another quote to hook up an associated ice maker). The contractor 404 may preview a quote by pressing the “Preview My Quote” button 924. For example, the system may show the contractor 404 a portable document format (PDF) detailing the quote.

The example “Chat With Customer” section 916 includes a transcript section 926, a comment/question input box 928, an “Attach a Photo” hyperlink 930, and a “Send” button 932. The transcript section 926 shows any prior communication between the contractor 404 and the customer 406. For example, the contractor 404 may have asked the customer 406 for additional information about the job (e.g., dimensions), and the customer 406 may have then responded with the additional information. The comment/question input box 928 allows the contractor 404 to enter text to be sent to the customer 406. For example, the contractor 404 may ask the customer 406 to send certain information (e.g., additional photographs, dimensions, etc.) that will help the contractor 404 determine a price quote and/or date quote. The contractor 404 may use the “Attach a Photo” hyperlink 930 to include one or more images with the message to the customer 406. For example, the contractor 404 may send the customer 406 an example of the type of photograph the contractor 404 would like to see from the customer 406, or the contractor 404 may send a form to the customer 406 to fill out. Once the contractor 404 has entered text in the comment/question input box 928 and attached any images using the “Attach a Photo” hyperlink 930, the contractor 404 may press the “Send” button 932 to send the message to the customer 406. For example, an email message may be sent to the customer 406 with the quote attached and/or in the body of the email. In this example, the email message may include a hyperlink that takes the customer 406 to a website where the quote may be selected.

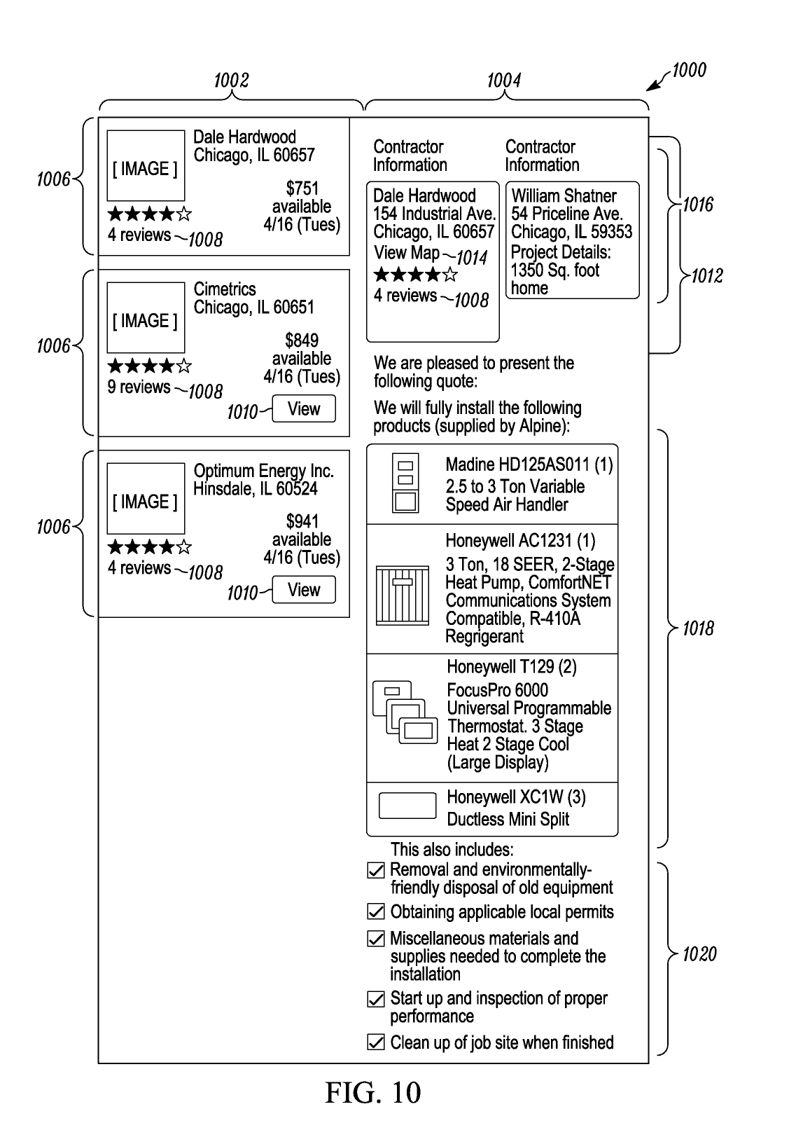

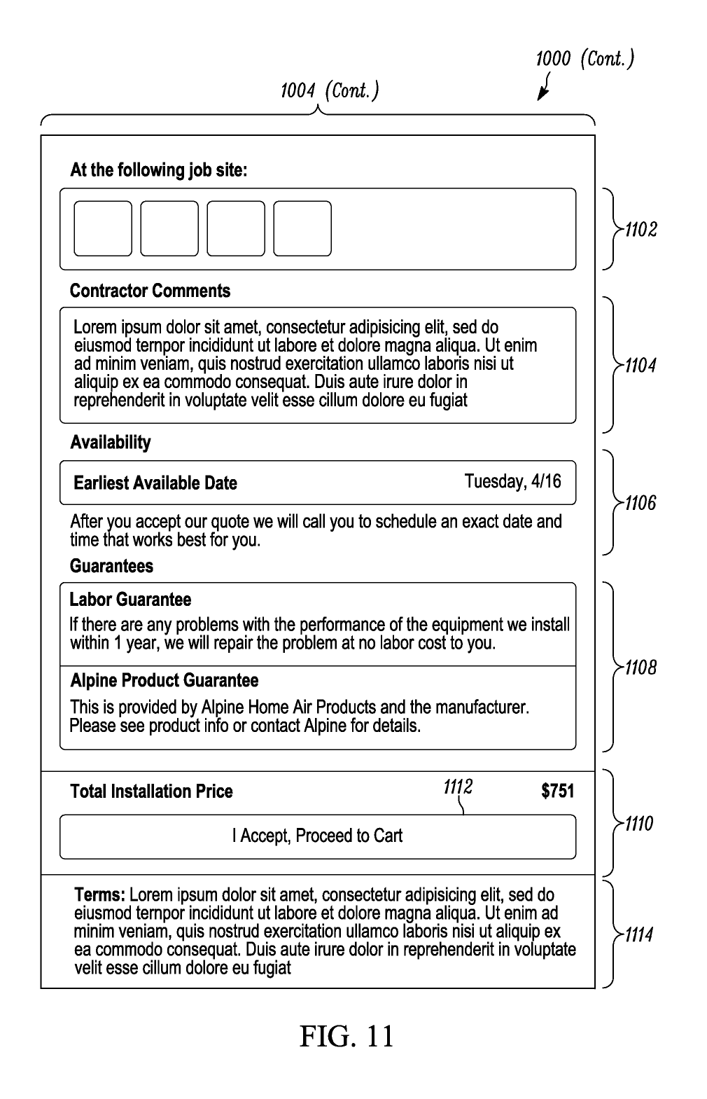

An example quote selection screenshot 1000 is illustrated in FIGS. 10-11. In this example, the quote selection screen 1000 includes a contractor selection section 1002 and a detailed quote section 1004. The example contractor selection section 1002 includes a plurality of quote thumbnails 1006. Each example quote thumbnail 1006 includes information about the contractor 404, such as a company name, an abbreviated company address, and an average reviewer's rating. The quote thumbnail 1006 also includes a “X reviews” hyperlink 1008. The customer 406 may click on the “X reviews” hyperlink 1008 to see reviews of that contractor 404 by other users. Each example quote thumbnail 1006 also includes information about the quote, such as the price and first available date. The customer 406 can see additional details about the contractor 404 and the quote by pressing a “View” button 1010 associated with quote thumbnail 1006.

When a “View” button 1010 associated with a quote is pressed, the additional details about the contractor 404 and the quote are displayed in the detailed quote section 1004. In this example, the detailed quote section 1004 includes detailed contractor information 1012, such as the company name, a full company address, the average reviewer's rating, and a professional rating (e.g., Better Business Bureau letter grade). The detailed contractor information 1012 also includes a “View Map” hyperlink 1014. The customer 406 may click on the “View Map” hyperlink 1014 to see a map including the contractor's location. In some embodiments, the map also includes the jobsite location, a path between the locations, a distance between the locations, and/or an approximate driving time to go from one of the locations to the other location. The detailed contractor information 1012 also includes the “X reviews” hyperlink 1008. Again, the customer 406 may click on the “X reviews” hyperlink 1008 to see reviews of that contractor 404 by other users 114.

The example detailed quote section 1004 also includes customer information 1016. In this example, the customer information 1016 includes the customer's name, address, and project details. For example, the project details may include a name for the project. The example detailed quote section 1004 also includes a product description section 1018, which lists each of the products previously selected by the customer 406 that require some type of service, such as installation. The example detailed quote section 1004 also includes an additional services section 1020, which lists additional services that will be performed such as removal of old equipment, obtaining any applicable permits, supplying materials needed to complete the service, startup and inspection of any new equipment, clean-up of job site when finished, etc.

As shown in FIG. 11, the example detailed quote section 1004 also includes a “At the following job site” section 1102. The “At the following job site” section 1102 may include job site photos uploaded by the customer 406, such as the job site photos described with reference to the “Job Site Photos” section 910 above. For example, the customer 406 may upload photos of an existing air conditioner. The example detailed quote section 1004 also includes a “Contractor Comments” section 1104. For example, the “Contractor Comments” section 1104 may include additional information about the job and/or the quote that the contractor 404 was not able to otherwise enter via the contractor bid creation screen 900. The example detailed quote section 1004 also includes an “Availability” section 1106. For example, the “Availability” section 1106 may include the earliest available date entered by the contractor 404 in the “Earliest Available Date” input box 920 on the contractor bid creation screen 900.

The example detailed quote section 1004 also includes a “Guarantees” section 1108. For example, the “Guarantees” section 1108 may include a labor guarantee and/or a product guarantee. The example detailed quote section 1004 also includes a “Total Installation Price” section 1110. For example, the “Total Installation Price” section 1110 may include the bid price entered by the contractor 404 in the “Your Bid Price” input box 918 on the contractor bid creation screen 900. The example “Total Installation Price” section 1110 also includes an “I Accept, Proceed to Cart” button 1112. The customer 406 may select a particular contractor's bid by pressing the “I Accept, Proceed to Cart” button 1112. The example detailed quote section 1004 also includes a “Terms” section 1112. For example, the “Terms” section 1112 may include any additional terms associated with the contract.

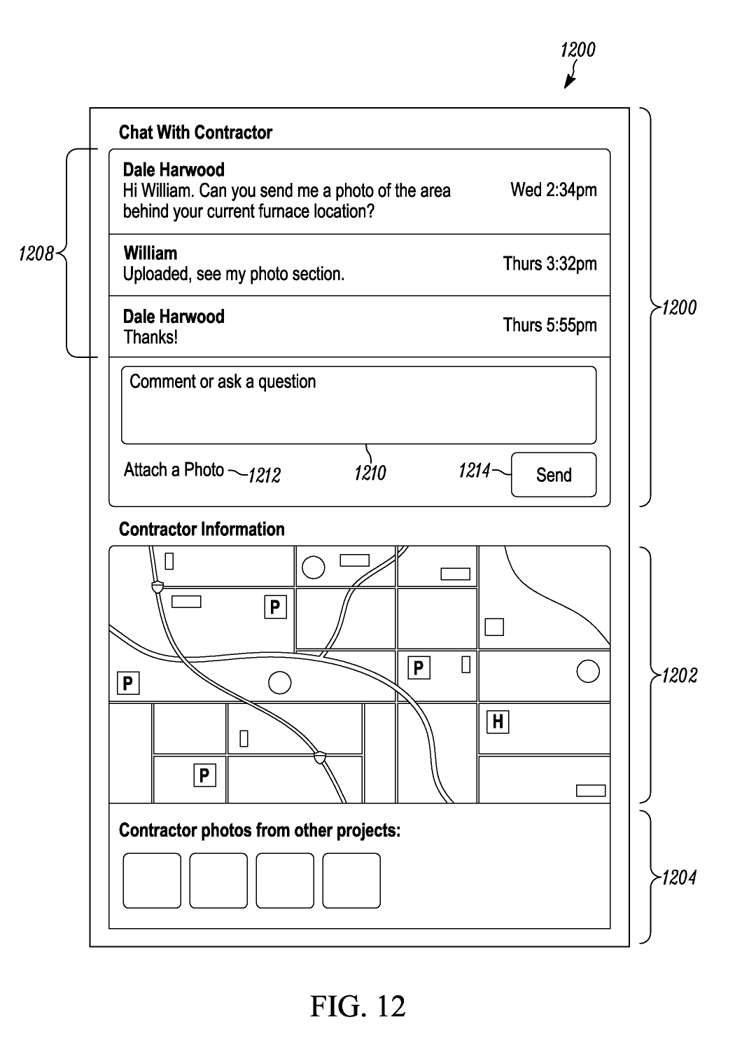

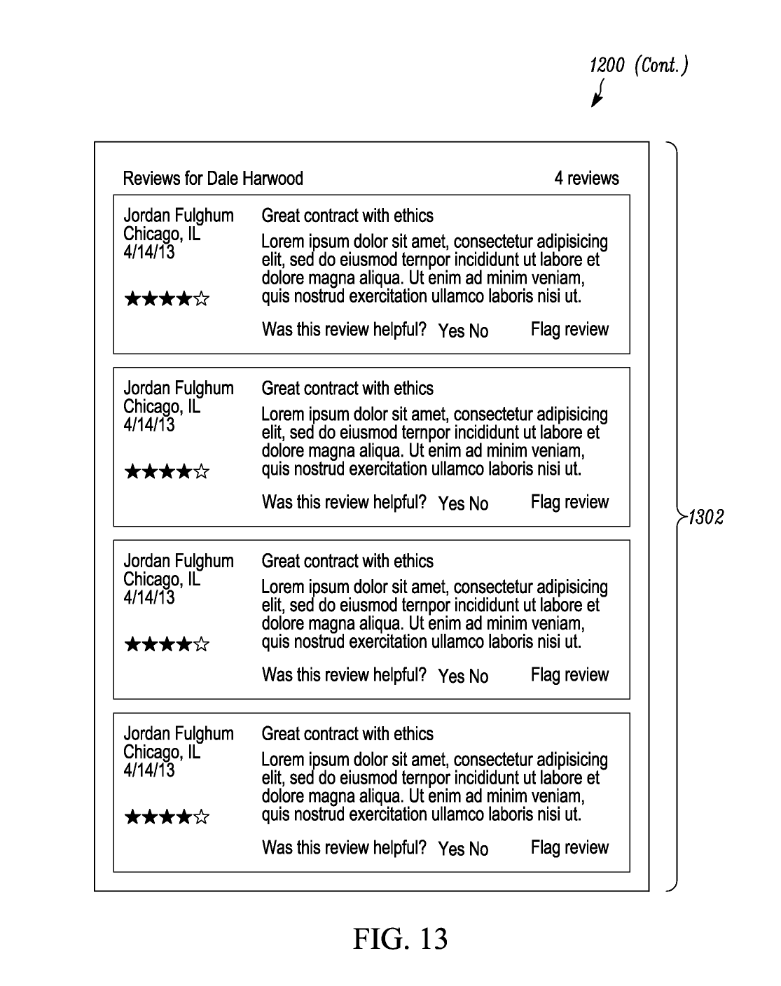

An example contractor/customer interaction screenshot 1200 is illustrated in FIGS. 12-13. In this example, the contractor/customer interaction screen 1200 includes a “Chat With Contractor” section 1200, a “Contractor Information” section 1202, a “Contractor photos from other projects” section 1204, and, as shown in FIG. 13, a “Reviews” section 1206.

The example “Chat With Contractor” section 1200 includes a transcript section 1208, a comment/question input box 1210, an “Attach a Photo” hyperlink 1212, and a “Send” button 1214. The transcript section 1208 shows any prior communication between the customer 406 and the contractor 404. For example, the contractor 404 may have asked the customer 406 for additional information about the job (e.g., dimensions), and the customer 406 may have then responded with the additional information. The comment/question input box 1210 allows the customer 406 to enter text to be sent to the contractor 404. For example, the contractor 404 may ask the customer 406 to send certain information (e.g., additional photographs, dimensions, etc.) that will help the contractor 404 bring the right equipment to the jobsite. The customer 406 may use the “Attach a Photo” hyperlink 1212 to include one or more images with the message to the contractor 404. For example, the customer 406 may send the contractor 404 additional photos requested by the contractor 404. Once the customer 406 has entered text in the comment/question input box 1210 and attached any images using the “Attach a Photo” hyperlink 1212, the customer 406 may press the “Send” button 1214 to send the message to the contractor 404. For example, an email message may be sent to the contractor 404 with a hyperlink that takes the contractor 404 to the “Chat With Customer” section 916 described above.

The example “Contractor Information” section 1202 includes a map including the contractor's location. In some embodiments, the map also includes the jobsite location, a path between the locations, a distance between the locations, and/or an approximate driving time to go from one of the locations to the other location. The example “Contractor photos from other projects” section 1204 includes photos of other similar jobs this contractor 404 has performed. For example, the contractor 404 may upload photos of other in-wall ovens the contract has installed. The example “Reviews” section 1302 (FIG. 13) includes reviews of this contractor 404 by other users 114. Each review may include a rating, such as a rating from zero (i.e., worst) to five stars (i.e., best).

In summary, persons of ordinary skill in the art will readily appreciate that methods and apparatus for facilitating delivery of a service associated with a product have been provided. Among other features, systems employing the disclosed system are able to offer a potential customer 406 one integrated purchase and service provider decision experience.

The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

1. A computer implemented method of facilitating delivery of a service associated with a product, the method comprising:
receiving a first product identifier associated with a first product in response to a first selection of the first product at a first retail website hosted by a web server;
receiving first jobsite information associated with the first product, the first jobsite information including first text describing at least one aspect of a first jobsite and a first picture of the first jobsite, wherein the first picture is different than the first jobsite information;
sending the first product identifier and the first jobsite information to one or more service providers;
receiving a first plurality of bids based on the first product identifier and the first jobsite information;
transmitting first data to a client device, wherein the data is indicative of a first graphical user interface allowing selection of at least one member of the first plurality of bids;
receiving a first bid selection; and
facilitating a first servicing of the first product.

2. The method of claim 1, further comprising:
receiving a second product identifier associated with a second product in response to a second selection of the second product at a second different retail website;
receiving second jobsite information associated with the second product, the second jobsite information including second text describing at least one aspect of a second jobsite and a second picture of the second jobsite;
receiving a second plurality of bids based on the second product identifier and the second jobsite information;
transmitting second data indicative of a second graphical user interface allowing selection of at least one member of the second plurality of bids;
receiving a second bid selection; and
facilitating a second servicing of the second product.

3. The method of claim 1, wherein receiving the first jobsite information includes receiving a video of the first jobsite.

4. The method of claim 1, wherein receiving the first jobsite information includes a user selection of predetermined text describing the at least one aspect of the first jobsite.

5. The method of claim 1, wherein receiving the first jobsite information includes a user entry of text describing the at least one aspect of the first jobsite.

6. The method of claim 1, wherein receiving the first plurality of bids includes at least one of receiving a job cost, a job start time, and a job duration.

7. The method of claim 1, wherein facilitating the first servicing of the first product includes at least one of generating a contract, scheduling an appointment, and billing.

8. The method of claim 1, wherein the first servicing of the first product includes at least one of installation, assembly, arrangement, setup, hookup, and configuration of the first product.

9. The method of claim 1, further comprising shipping the first product.

10. The method of claim 9, wherein receiving the first jobsite information includes receiving a shipping address associated with the first jobsite, and shipping the first product includes shipping the first product to the shipping address.

11. An apparatus for facilitating a delivery of a service associated with a product, the apparatus comprising:
a processor;
an network interface operatively coupled to the processor; and
a memory device operatively coupled to the processor, the memory device storing instructions to cause the processor to:
receive a first product identifier associated with a first product in response to a first selection of the first product at a first retail website;
receive first jobsite information associated with the first product, the first jobsite information including first text describing at least one aspect of a first jobsite and a first picture of the first jobsite, wherein the first picture is different than the first jobsite information;
send the first product identifier and the first jobsite information to one or more service providers;
receive a first plurality of bids based on the first product identifier and the first jobsite information;
transmit first data indicative of a first graphical user interface allowing selection of at least one member of the first plurality of bids;
receive a first bid selection; and
facilitate a first servicing of the first product.

12. The apparatus of claim 11, wherein the instructions are structured to cause the processor to:
receive a second product identifier associated with a second product in response to a second selection of the second product at a second different retail website;
receive second jobsite information associated with the second product, the second jobsite information including second text describing at least one aspect of a second jobsite and a second picture of the second jobsite;
receive a second plurality of bids based on the second product identifier and the second jobsite information;
transmit second data indicative of a second graphical user interface allowing selection of at least one member of the second plurality of bids;
receive a second bid selection; and
facilitate a second servicing of the second product.

13. The apparatus of claim 11, wherein the instructions are structured to cause the processor to receive a video of the first jobsite.

14. The apparatus of claim 11, wherein the instructions are structured to cause the processor to receive a user selection of predetermined text describing the at least one aspect of the first jobsite.

15. The apparatus of claim 11, wherein the instructions are structured to cause the processor to receive a user entry of text describing the at least one aspect of the first jobsite.

16. The apparatus of claim 11, wherein the instructions are structured to cause the processor to receive a job cost, a job start time, and a job duration.

17. The apparatus of claim 11, wherein the instructions are structured to cause the processor to generate a contract, an appointment, and a bill.

18. The apparatus of claim 11, wherein the first servicing of the first product includes at least one of installation, assembly, arrangement, setup, hookup, and configuration of the first product.

19. An non-transitory computer readable medium storing instructions to cause a computing device to:
receive a first product identifier associated with a first product in response to a first selection of the first product at a first retail website;
receive first jobsite information associated with the first product, the first jobsite information including first text describing at least one aspect of a first jobsite and a first picture of the first jobsite, wherein the first picture is different than the first jobsite information;
send the first product identifier and the first jobsite information to one or more service providers;
receive a first plurality of bids based on the first product identifier and the first jobsite information;
transmit first data indicative of a first graphical user interface allowing selection of at least one member of the first plurality of bids;
receive a first bid selection; and
facilitate a first servicing of the first product.

20. The non-transitory computer readable medium of claim 19, wherein the instructions are structured to cause the computing device to:
receive a second product identifier associated with a second product in response to a second selection of the second product at a second different retail website;
receive second jobsite information associated with the second product, the second jobsite information including second text describing at least one aspect of a second jobsite and a second picture of the second jobsite;
receive a second plurality of bids based on the second product identifier and the second jobsite information;
transmit second data indicative of a second graphical user interface allowing selection of at least one member of the second plurality of bids;
receive a second bid selection; and
facilitate a second servicing of the second product.

21. The non-transitory computer readable medium of claim 19, wherein the instructions are structured to cause the computing device to receive a video of the first jobsite.

22. The non-transitory computer readable medium of claim 19, wherein the instructions are structured to cause the computing device to receive at least one of (a) a user selection of predetermined text describing the at least one aspect of the first jobsite, and (b) a user entry of text describing the at least one aspect of the first jobsite.

23. The non-transitory computer readable medium of claim 19, wherein the instructions are structured to cause the computing device to receive a job cost, receive a job start time, receive a job duration, generate a contract, generate an appointment, and generate a bill.

24. The non-transitory computer readable medium of claim 19, wherein the first servicing of the first product includes at least one of installation, assembly, arrangement, setup, hookup, and configuration of the first product.

25. A computer implemented method of facilitating delivery of a service associated with a product, the method comprising:
receiving a first product identifier associated with a first product in response to a first selection of the first product at a first retail website hosted by a web server;
receiving first jobsite information associated with the first product, the first jobsite information including first text describing at least one aspect of a first jobsite and a first picture of the first jobsite, wherein the first picture is different than the first jobsite information;
sending the first product identifier and the first jobsite information to one or more service providers;
receiving a first plurality of bids based on the first product identifier and the first jobsite information;
selecting a first bid;
transmitting first data to a client device, wherein the data is indicative of a first graphical user interface allowing approval of the first of bid; and
facilitating a first servicing of the first product.

26. The method of claim 25, further comprising:
receiving a second product identifier associated with a second product in response to a second selection of the second product at a second different retail website;
receiving second jobsite information associated with the second product, the second jobsite information including second text describing at least one aspect of a second jobsite and a second picture of the second jobsite;
receiving a second plurality of bids based on the second product identifier and the second jobsite information;
selecting a second bid;
transmitting second data indicative of a second graphical user interface allowing approval of the second of bid; and
facilitating a second servicing of the second product.

27. The method of claim 25, wherein receiving the first jobsite information includes receiving a video of the first jobsite.

28. The method of claim 25, wherein receiving the first jobsite information includes receiving at least one of (a) a user selection of predetermined text describing the at least one aspect of the first jobsite, and (b) a user entry of text describing the at least one aspect of the first jobsite.

29. The method of claim 25, wherein receiving the first plurality of bids includes receiving a job cost, a job start time, and a job duration, and wherein facilitating the first servicing of the first product includes generating a contract, an appointment, and a bill.

30. The method of claim 25, wherein the first servicing of the first product includes at least one of installation, assembly, arrangement, setup, hookup, and configuration of the first product.

31. The method of claim 1, including transmitting a map including a contractor's location.

32. The method of claim 1, including transmitting a map including a jobsite location.

33. The method of claim 1, including transmitting a map including a path between a contractor's location and a jobsite location.

34. The method of claim 1, including transmitting a map including a distance between a contractor's location and a jobsite location.

35. The method of claim 1, including transmitting a map including a driving time between a contractor's location and a jobsite location.

36. The method of claim 1, including transmitting a photo of another job a contractor has performed.

37. The method of claim 1, including transmitting a transcript showing a prior communication between a contractor and a customer.

38. The method of claim 1, including transmitting a review of a contractor by a user.

39. The method of claim 38, wherein the review includes a rating of the contractor by the user.
